(19) United States
(12) Patent Application Publication
(10) Pub. No.: US 2002/0182385 A1
(43) Pub. Date: Dec. 5, 2002

(54) Atomic layer passivation

(75) Inventors: John Joseph Senkevich, Troy, NY (US); Toh-Ming Lu, Loudonville, NY (US); Guangrong Yang, Troy, NY (US)

Correspondence Address: HESLIN ROTHENBERG FARLEY & MESITI PC, 5 COLUMBIA CIRCLE, ALBANY, NY, 12203, US

(73) Assignee: Rensselaer Polytechnic Institute, Troy, NY (US)

(21) Appl. No.: 10/157,210

(22) Filed: May 29, 2002

Related U.S. Application Data
(60) Provisional application No. 60/293,950, filed on May 29, 2001.

(51) Int. Cl. B32B 3/00

(52) U.S. Cl. 428/209; 174/259

(57) ABSTRACT

Materials and surfaces terminated with sulfur, phosphorous, antimony, selenium, tellurium, bromine and/or iodine atoms are suitable for the manufacture of metallic thin films by deposition of highly polarizable transition metals over an atomic passivation layer or a self-assembled layer.

### CROSS REFERENCE TO RELATED APPLICATIONS

This application claims priority from U.S. provisional application, serial number 60/293,950, filed May 29, 2001.

### FIELD OF THE INVENTION

The invention relates to materials and surfaces that are suitable for the manufacture of metallic thin films.

### BACKGROUND OF THE INVENTION

The metallization of dielectrics has had a long history of industrial and academic interest (Mittal Ed., Metallized Plastics 5&6 Fundamental and Applied Aspects, VSP, Utrecht, The Netherlands (1998)). A fundamental difficulty that exists when trying to metallize a dielectric is the difference in surface free energies between the deposited metal and the dielectric surface. The relationship between surface free energy of the metal, dielectric and interface can be conceptualized using equation 1:

γₘₑₜₐₗ−γ_{dielectric}+γ_{interfacial}<0 (1)

where γₘₑₜₐₗ is the surface free energy of the metal, γ_{dielectric} is the surface free energy of the dielectric and γ_{interfacial} is the interfacial surface free energy of the interface, e.g. the bond energy between the metal and dielectric. Typically, metals possess much higher surface free energies compared to dielectrics (Overbury et al., Chemical Reviews 75(5):547-560 (1975)). Therefore, for wetting to occur, the above equation has to be valid and then the interfacial free energy or bond energy should be appreciably large. The ‘soft’ transition metals, those residing on the right hand side of the periodic table, e.g. copper, zinc, cadmium, mercury, gold, silver, and the noble metals typically do not possess large bond energies with oxygen. In other words, they interact weakly with oxygen, possessing low interfacial free energies. As a result, they do not ‘wet’ metal oxide dielectrics and have a problem with adhesion. Poly(tetrafluoroethylene), poly(p-xylylene), and arylene ethers typically contain a majority of the chemical moieties C—F and C—H that also weakly interact with metals and therefore the same problem exists with the metallization of polymeric materials. Metal diffusion barrier layer material also interact weakly with metals, and can be difficult to metallize.

To tackle the problem of dielectric metallization various surface modifications have been developed to change the surface chemistry of the dielectric allowing for strong interfacial bonding to occur, which will also promote strong chemisorption to metallorganics. These methods may be characterized as either dry, as in a vacuum process, or solution-borne, as with the use of solvents. The dry methods typically use radio frequency or microwave plasmas and use some kind of oxidizing environment, e.g. H₂O (Goldblatt et al., J. Appl. Polym. Sci. 46:2189-2202 (1992)), O₂ (Kondoh et al., Mater. Res. Soc. Symp. Proc. 476:81-86 (1997)), N₂ (Flitsch et al., J. Vac. Sci. Technol. A 8(3):2376-2381 (1990)), N₂O (Porta et al., Chem. Mater. 3(2):293-298 (1991)) NH₃ (Kurdi et al., in Metallized Plastics 5&6 Fundamental and Applied Aspects, VSP, Utrecht, The Netherlands (1998) pp. 295-317), for both polymeric and dielectric materials. Further, the use of heavy noble atoms, e.g. Ar, during the sputtering of metallic materials onto dielectric surface can induce bond rupture thereby making strong interfacial reactions between the metal and the dielectric possible (Chapman, Glow Discharge Processes, John Wiley & Sons, New York, N.Y. (1980)).

Solution-borne methods to modify polymeric materials may include oxidizing reagents such as H₂CrO₄+H₂SO₄ (Rantell, Trans. Institute Metal Finishing 47:197-202 (1969)), KClO₃+H₂SO₄ (Bening et al., Macromolecules 23:2648-2655 (1990)), H₂CrO₄ (Bag et al., J. Appl. Polym. Sci. 71:1041-1048 (1999)), fuming H₂SO₄ (Fischer et al., J. Appl. Polym. Sci. 52:545-548 (1994)), solvated electrons e.g. low temperature Mg/NH₃ (Brace et al., Polymer 38(13):3295-3305 (1997)), KMnO₄ (Borisova et al., Kolloidnyi Zhurnal 28(6):792-796 (1966)), OsO₄ (Ghiradella et al., J. Appl. Polym. Sci. 23(5):1583-1584 (1979)), NH₃+AlCl₃ (Yun et al., Polymer 38(4):827-834 (1997)), HNO₃+H₂SO₄ (Clark et al., in ACS Symp. Ser. 162 (1981) pp. 247-91). The solution-borne methods are varied and diverse but the aim is to change the surface chemistry and the dielectric surface to allow it to become more reactive with the metallic thin film thus enabling a larger interfacial surface free energy to exist.

The deposition of copper thin films is of particular interest since there is much economic interest in such films. Copper can be deposited as a thin film by electrochemical deposition (ECD) (Prosini et al., Thin Solid Films 298(1,2):191-196 (1997)), electroless deposition, magnetron sputtering (Kriese et al., Mater. Res. Soc. Symp. Proc. 473:39-50 (1997)), electron-beam, thermal, chemical vapor deposition (CVD) (Kim et al., J. Vac. Sci. Technol. A 12(1):153-7 (1994)), and atomic layer deposition (ALD) (Martensson et al. J. Electrochem. Soc. 145(8):2926-2931 (1998)). In nearly every case except sputtering an appropriate surface chemistry must exist at the surface to allow high quality copper films to be deposited. In the case of ECD, electroless deposition, and ALD no deposition takes place on dielectrics without an appropriate ‘seed layer’ or surface passivation. Typically palladium is used as a ‘seed layer’ for ECD and ALD. It has been reported that sulfur passivation via (NH₄)₂S solution, Na₂S solution (Yang et al., J. Electrochem. Soc. 143(11):3521-3525 (1996)) and sulfur residing in a CS₂ solvent is an appropriate passivation for the copper ECD on dielectric surfaces (Gulla et al. U.S. Pat. No. 4,810,333) (Bladon U.S. Pat. No. 4,895,739) (Bladon U.S. Pat. No. 4,919,768) (Bladon et al. U.S. Pat. No. 4,952,286) (Bladon U.S. Pat. No. 5,007,990). However, there is a need for alternate methods for passivating a surface to be metallized.

Therefore, one object of the invention is to use atomic layer passivation and self-assembled monolayer/multilayer passivation to allow the deposition of metal thin films via the above aforementioned techniques.

A further object of the invention is the development of passivation methods to promote the chemisorption of metallorganics, source precursors for metals such as Cu, Pd, Pt, Ir, Rh, Os, Au, Re Co, Ni, Nb on dielectric and diffusion barrier surfaces.

A yet further object of the invention is the development of passivation methods to allow the wetting of metals on dielectric and diffusion barrier materials.

A yet further object of the invention is the development of good adhesion between the metal and the dielectric or diffusion barrier layer using passivation methods.

An additional object of the invention is to develop both dry and solution-borne methods to passivate dielectrics and diffusion barriers to allow for high quality metal thin films to be deposited.

### BRIEF DESCRIPTION OF THE DRAWINGS

The invention will be described with respect to the particular embodiments thereof. Other objects, features, and advantages of the invention will become apparent with reference to the specification and drawing in which:

FIG. 1 illustrates the relationship between the metal, dielectric, and the interface in terms of their surface free energies

FIG. 2 illustrates the relationship between the metal thin film, the dielectric substrate, and atomic layer passivation and the elements that embody them.

FIG. 3 illustrates the relationship between the metal thin film, the dielectric, and self-assembled monolayer passivation (in some cases multilayer). The passivation surface like atomic layer passivation is one monolayer thick.

FIG. 4 shows 3-mercaptopropyltrimethoxysilane (mercaptan SAM) growth on native oxide as a function of time and temperature measured by variable angle spectroscopic ellipsometry. An index of refraction was assumed to be 1.458 @634.1 nm. 0.7 v/v% in anhydrous toluene in a PTFE beaker with a humidity of 65-80%.

FIG. 5 2 pulses of Pd^{II}(hfac)₂ on sulfur passivated surfaces in the sequence Pd/Ar (20/3 sec.) waiting until base pressure is reached between pulses at T_{dep}=175° C., T_{sublimator}=34.8° C. The Si2p peak is used as an internal reference at 99.15 eV. Inlet shows Pd^{II}(hfac)₂ and the surface chemistry (disulfide, oxidized sulfur, and hydroxyl groups).

FIG. 6 The XPS S2p peak from the same surfaces as FIG. 5 without any deposited palladium.

FIG. 7 2 pulses of Pd^{II}(hfac)₂ on sulfur passivated surfaces in the sequence Pd/Ar/H₂/Ar (20/3/20/3 sec.) waiting until base pressure is reached between pulses at T_{dep}=175° C., T_{sublimator}=34.8° C. as in FIG. 5.

FIG. 8 has the same conditions as in FIG. 5. A comparison between the multilayer mercaptan SAM (27.5 Å) and Ir substrates for the Pd3d_{5/2} and Pd3d_{3/2} XPS spectra.

FIG. 9 has the same conditions as in FIG. 5. A comparison between the monolayer mercaptan SAM after 1 min and 15 min of exposure to the SAM/Toluene solution for the Pd3d_{5/2} and Pd3d_{3/2} XPS spectra. Both SAM's have the same thickness (8.0±0.7 Å).

FIG. 10 shows the S2p spectrum of the sulfur atomic layer passivated SiO₂ at 100 mTorr of pressure and H₂S/He 50WRF power.

FIG. 11 shows the S2p spectrum of the sulfur atomic layer passivated SiO₂ at 100 mTorr of pressure and H₂S/He 150WRF power.

FIG. 12 shows the Pd3d_{5/2} and Pd3d_{3/2} spectra for palladium deposited by two 20 sec pulses of Pd^{II}(hfac)₂ on the sulfur atomic layer passivated SiO₂ at 100 mTorr of pressure.

FIG. 13 shows a schematic of the vacuum deposition system for depositing metallic thin films via chemical vapor deposition, pulsed chemical vapor deposition, or atomic layer deposition. It also maybe used to deposit self-assembled monolayers via a dry process.

FIG. 14 shows the capacitively-coupled RF plasma vacuum system for the atomic layer passivation of S, P, Se, Te, Sb, Br or I via a dry process.

FIG. 15 compares the tetrasulfide SAM, the iodo SAM and a hydroxylated SiO₂ surfaces after the deposition of palladium using Pd^{II}(hfac)₂ pulsed twice for 20s. using the sequence Pd/Ar at 175° C.

FIG. 16 is a Ta4f XPS spectrum of the as-deposited Ta surface. Ta forms a relatively thick oxide overlayer, >50 Å.

FIG. 17 shows the S2p XPS spectra of the sulfur ALP on air exposed Ta surface with increasing Rf power from bottom to top, exposed to a H₂S/He (200 sccm each) plasma at 60 mTorr system pressure for 5 min at 15° C.

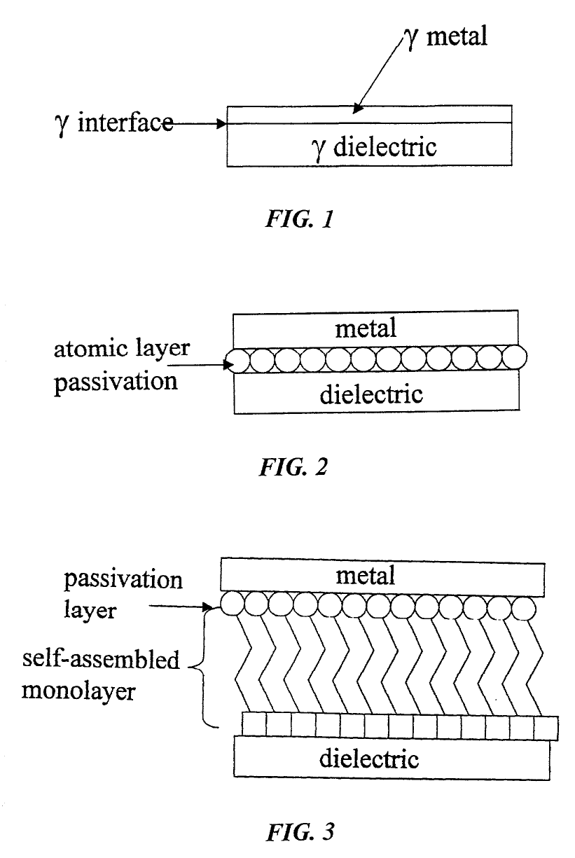

### SUMMARY OF THE INVENTION

In one aspect, the present invention relates to a method for metallizing a substrate. The method includes providing a precursor for an element selected from the group consisting of sulfur, selenium, tellurium, phosphorus, antimony, iodine and bromine; depositing, directly on a surface of the substrate, an atomic passivation layer comprising at least one of said elements; and forming, directly on the atomic passivation layer, a metallic layer comprising at least one metallic element selected from the group consisting of Zn, Cu, Ni, Co, Fe, Sb, Sn, In, Cd, Ag, Pd, Rh, Ru, Bi, Pb, Tl, Hg, Au, Pt, Ir, Os, Re, W, Ta, Hf, Nd, Sm, Eu, and Gd. The precursor is in vapor form. The substrate may be a dielectric material, or a diffusion barrier material, and may be composed of ceramic materials having an oxide surface, organic polymers or organic/inorganic hybrid materials. In particular, atomic passivation layer composed of sulfur and/or phosphorus are of interest.

In another aspect, the present invention relates to a metallized substrate including a substrate comprising a dielectric or a diffusion barrier material; an atomic passivation layer, directly disposed on a surface of the substrate, and comprising at least one element selected from the group consisting of sulfur, phosphorus, antimony, selenium, tellurium, iodine and bromine; and a metallic layer directly disposed on the atomic passivation layer, and comprising at least one metallic element selected from the group consisting of Zn, Cu, Ni, Co, Fe, Sb, Sn, In, Cd, Ag, Pd, Rh, Ru, Bi, Pb, Tl, Hg, Au, Pt, Ir, Os, Re, W, Ta, Hf, Nd, Sm, Eu, and Gd. In particular, the metallic layer may be copper.

In yet another aspect, the present invention relates to a metallized diffusion barrier layer including a diffusion barrier layer; and a passivation layer, disposed directly on a surface of the diffusion barrier layer, and comprising a silyl-anchored self-assembled monolayer or self-assembled multilayer, terminated with at least one element selected from the group consisting of sulfur, selenium, tellurium, phosphorus, antimony, iodine and bromine. The passivation layer may be derived from an alkoxy- or chlorosilane comprising an element selected from the group consisting of S, P, Sb, Se, Te, I and Br. In particular, the passivation layer may be sulfur.

The invention comprises methods to passivate the surface of dielectrics, e.g. polymeric materials and hybrid materials and materials that form oxide surfaces to enable metallic thin films to be deposited. Such materials maybe low K dielectrics, high K dielectrics, metal oxides, hybrid materials composed of organic and inorganic constituents, polymeric materials, and diffusion barrier materials.

Thus one aspect of the invention relates to the development of methods to passivate dielectrics.

Another aspect of the invention is the development of passivation methods that are comprised of both dry (in vacuum) and solution-borne (use of solvents).

Yet another aspect of the invention relates to surfaces that are composed of either atomic (atomic layer passivation) or molecular layers (self-assembled chemistry or covalent attachment).

Another aspect of the invention relates to metallization of dielectric materials for optics manufacturing.

A further aspect of the invention relates to metallization (via and trench metallization) for an ultra large scale integration (ULSI) devices.

### DETAILED DESCRIPTION OF THE INVENTION

The present invention relates to passivation methods and materials enabling metallic thin films to be deposited on surfaces by electrochemical deposition (ECD), electroless deposition, magnetron sputtering, electron-beam, thermal, chemical vapor deposition (CVD, and atomic layer deposition (ALD). ECD, electroless deposition and ALD are particularly relevant, since little if no deposition can take place on dielectrics without a ‘seed’ layer or the passivation methods according to this invention. In the context of the present invention, the term “passivation” refers to altering the surface of a substrate chemically, in a manner facilitating metal deposition on the modified surface. The passivation films can exist as two varieties for the invention, atomic layer passivation and self-assembled chemistry. Atomic layer passivation maybe defined as the use of one (or a few) atomic layer(s) to change the surface chemistry of the substrate allowing metallic deposition to occur where otherwise such deposition would not occur or the properties of the metal thin films would be poor. FIG. 2 illustrates this idea. Therefore, in one aspect, the present invention relates to methods/processes for atomic layer passivation, and the compositions/structures that may be produced thereby. An atomic layer according to the present invention may be composed of sulfur, selenium, tellurium, phosphorus, antimony, iodine, bromine or mixtures thereof. In some embodiments, the composition of the atomic layer may be limited to sulfur and/or phosphorus.

Passivation via self-assembled chemistry refers to the use of monolayer or multilayers of molecules that assemble themselves on a surface due to specific bonding sites that exist at that surface. FIG. 3 illustrates this idea. Self-assembled monolayer/multilayer passivation is generally thicker than atomic layer passivation since the surface layer is comprised of molecules rather than atoms.

Substrates that may be passivated using the methods of the present invention include dielectrics and diffusion barriers for metals or halogens. Diffusion barriers, also known as diffusion barriers, or simply barrier layers, prevent migration of metals or halogens and may be conducting or insulating materials. Excluded from substrates that may be passivated using the processes of the present invention are III-V compounds used as photonic semiconductors, such as GaAs, IAIs, InP, GaP, InAs, AlₓGa₁₋ₓAs, GaₓIn₁₋ₓAs, and GaₓIn₁₋ₓP.

Dielectric substrates include ceramic oxides, and/or materials having a surface composed of a ceramic oxide, such as silicon having a surface coating of silicon dioxide; organic polymers, and organic/inorganic hybrid materials, such as silicon dioxide doped with organic components. Suitable ceramic oxides for use as a substrate include, for example, oxides of aluminum, titanium, zirconium, hafnium, tantalum, niobium, magnesium, yttrium, cerium, calcium and/or silicon; in particular, SiO₂ may be used. Examples of non-metal ceramic oxides are bismuth oxide and beryllium oxide. Mixed compounds and/or binary, ternary and quaternary oxides such as aluminum silicates, SiAlON, mullite (Al₂O₃.SiO₂), and spinel (MgO.Al₂O₃) may be used. Suitable organic polymers are those used in the electronics industry as dielectrics. Examples include fluoropolymers, polyimides, fluorinated polyimides, poly-p-xylene and arylene ethers. Examples of suitable fluoropolymers include polytetrafluoroethylene (PTFE) and modified polytetrafluoroethylene. Modified PTFE contains from 0.01% to 15% of a comonomer such as a fluorinated alkyl vinyl ether, vinylidene fluoride, hexafluoropropylene, or chlorotrifluoroethylene, which enables the particles to fuse better into a continuous film. High levels of modification leads to polymers such as PFA poly(perfluorinatedalkylvinylethertetrafluoroethylene) or FEP poly(perfluorinated tetrafluoroethylenehexafluoropropylene). Other fluoropolymers which may serve as a dielectric include: polychlorotrifluoroethylene; copolymers of chlorotrifluoroethylene with vinylidene fluoride, ethylene, and/or tetrafluoroethylene; polyvinylfluoride; polyvinylidenefluoride; and copolymers or terpolymers of vinylidene fluoride with TFE or HFP; and copolymers containing fluorinated alkylvinylethers. Other fluorinated, non-fluorinated, or partially fluorinated monomers that might be used to manufacture a copolymer or terpolymer with the previously described monomers might include: perfluorinated dioxozoles or alkyl substituted dioxozoles; perfluorinated or partially fluorinated butadienes; vinylesters; and alkylvinyl ethers. Hydrogenated fluorocarbons from C2-C8 may also be used. These would include trifluroethylene, and hexafluoro-isobutene. Fluoroelastomers, such as HFP with VDF; HFP, VDF, TFE copolymers; TFE-perfluorinated alkylvinylether copolymers; TFE copolymers with hydrocarbon comonomers such as propylene; and TFE, propylene, and vinylidene fluoride terpolymers may also be used. Fluoroelastomers can be cured using crosslinking agents, such as diamines (hexamethylenediamine), a bisphenol cure system (hexafluroorisopropylidene-diphenol); or peroxide (2,5-dimethyl-2,5-dit-butyl-peroxyhexane). A suitable organic/inorganic hybrid material is described in U.S. Pat. Nos. 5,874,367 and 6,287,989, assigned to Trikon Technologies, Ltd. This type of material may be described as a low κ flow layer formed through a condensation reaction between hydrogen peroxides and methyl silane.

Examples of conducting diffusion barrier materials include Ta, TaSiN, TaN, TiN, TiSiN, HfB₂, ZrB₂, TiB₂, and CoSi₂. Insulating diffusion barrier materials include, but are not limited to, magnesium oxide and alumina.

Metals that may be deposited on the atomic (passivation) layer are typically ‘soft’ metals, although, in some embodiments, ‘hard’ metals may be used. Hard/soft nomenclature is borrowed from acid/base chemistry. (See, for example, Huheey, Inorganic Chemistry, 3^{rd} edition, pages 312-325 (1983).) Accordingly, soft metals are defined as highly polarizable metals, such as the transition metals residing on the right side of the periodic table, in addition to metals having electrons in f-orbitals, including actinides and lanthanides, and highly polarizable non-transition metals and non-metals to the right of the transition metals on the periodic table, in contrast with hard metals such as scandium, titanium, vanadium, chromium, yttrium, zirconium, and molybdenum. In some embodiments, highly polarizable non-metals may also be used. Examples of suitable metals include Zn, Cu, Ni, Co, Fe, Sb, Sn, In, Cd, Ag, Pd, Rh, Ru, Bi, Pb, Tl, Hg, Au, Pt, Ir, Os, Re, W, Ta, Hf, Nd, Sm, Eu, and Gd. In some embodiments, suitable metals may be limited to Zn, Cu, Ni, Co, Fe, Cd, Ag, Pd, Rh, Hg, Au, Pt, Ir, and Os, and in others to Cu, Ag Au, Pd, Pt, Ir and Os. Alternatively, groups of useful metals may be defined by particular properties. For example, in some embodiments, the metal may be limited to catalytic metals, including Cu, Ni, Co, Fe, Mn, Pd, Rh, Pt, Ir, Os, Re, and Gd; to magnetic metals, including Ni, Co, Fe, Sm, Nd, and Dy; to solderable metals, including Sn, Bi, Pb, Pd, Ag, Cu, In, Sn, Ni, Zn, Au; or to metals used for electrical interconnects for integrated devices and circuit boards, such as copper. For all embodiments, mixtures of metals may be used. The metallic layer may be deposited using electrochemical deposition (ECD), electroless deposition, plasma sputtering, magnetron sputtering, electron-beam, thermal, chemical vapor deposition (CVD, atomic layer deposition (ALD) or chemical fluid deposition. (The chemical fluid deposition technique was developed by James Watkins and uses supercritical CO₂ (Blackburn, Jason M. ; Long, David P.; Cabanas, Albertina; Watkins, James J. “Deposition of conformal copper and nickel films from supercritical carbon dioxide” Science (Washington, D.C., United States) 294, No. 5540 (2001): 141-145)). In particular, the metal may be deposited by CVD or ALD, using a β-diketonate metal source precursor.

Therefore, in one aspect, the present invention relates to a vacuum process for metallizing a substrate. The process includes providing, in vapor form, a precursor for an element selected from sulfur, selenium, tellurium, phosphorous, antimony, iodine and bromine; depositing, directly on the surface of the substrate, an atomic passivation layer comprising at least one of the elements; and forming, directly on the atomic passivation layer, a metallic layer.

Examples of suitable precursors include H₂S, R₂S, H₂Se, H₂Te, SbH₃, PH₃, R₃P, HI, I₂, RI, and Br₂, wherein R is alkyl or aryl. More than one precursor may be used, if desired. The precursor(s) is typically activated or energized by exposure to energy source in order to facilitate deposition of the atomic layer. Examples of means for activating the precursors include forming a plasma thereof, and/or exposing the precursor and/or the substrate to thermal or optical energy. Suitable plasmas include radiofrequency (RF) or microwave plasmas, either near-surface or remote, such as capacitively coupled plasmas, inductively coupled plasmas, microwave cavity plasmas, and electron cyclotron resonance plasmas. Optical activation may be accomplished by exposing the source precursor and/or substrate to UV or laser irradiation.

The layer initially deposited may be either a monolayer or a multilayer; if a multilayer is initially deposited, all but an atomic layer is removed prior to metallization. For example, for sulfur deposited from hydrogen sulfide, a multilayer of composition S₈ may be deposited at low temperature (approximately 15° C.), which may be converted to an atomic layer by rinsing with carbon disulfide, or subliming the S8 at 130° C. Alternately, at high temperature (130° C. to 150° C.) only an atomic layer is formed. For phosphorous, any excess may be removed under vacuum, leaving an atomic layer. In another aspect, the present invention also relates to metallized substrates that may be produced using the vacuum processes of the invention. The substrate to be metallized is dielectric or a diffusion barrier material, as described above. An atomic layer comprising at least one element selected from sulfur, phosphorous, antimony, selenium, tellurium, iodine and bromine is directly disposed on a surface of the substrate, and a metallic layer is directly disposed on the atomic layer.

The metallic layer is composed of at least one metallic elements, and may include additional elements, if desired. Examples of suitable metals include Zn, Cu, Ni, Co, Fe, Sb, Sn, In, Cd, Ag, Pd, Rh, Ru, Bi, Pb, Tl, Hg, Au, Pt, Ir, Os, Re, W, Ta, Hf, Nd, Sm, Eu, and Gd. In some embodiments, the group of suitable metals may be limited to Zn, Cu, Ni, Co, Fe, Cd, Ag, Pd, Rh, Hg, Au, Pt, Ir, and Os, and in others to Cu, Ag Au, Pd, Pt, Ir and Os.

The present invention also relates to SAM passivation of metallized diffusion barrier layers. A passivated barrier layer according to the present invention comprises a diffusion barrier layer; and a passivation layer, disposed directly on a surface of the diffusion barrier layer. The passivation layer comprises a silyl-anchored self-assembled monolayer (SAM) or self-assembled multilayer (SAM), terminated with at least one element selected from the group consisting of sulfur, selenium, tellurium, phosphorus, antimony, iodine and bromine. The SAM passivation layer may be derived from an alkoxy- or chlorosilane comprising an element selected from the group consisting of S, P, Sb, Se, Te, I and Br. Materials suitable for the diffusion barrier layer are those described above.

Self-assembled monolayer/multilayers (SAM's) grow in an ordered structure due to the chemical anisotropy that exists within the molecules. Three types of SAM's are common: alkyl thiolate SAM's (on Ag, Au, and Cu) (Laibinis et al., J. Am. Chem. Soc. 113:7152-7167 (1991)), trichlorosilyl SAM's (on hydroxylated surfaces) (Vuillaume et al., Appl. Phys. Lett. 69(11):1646-1648 (1996)), and trialkoxysilyl SAMs (on hydroxylated surfaces) (Dressick et al., J. Electrochem. Soc. 141(1):210-220 (1994)). Namely, the alkylthiolate, trichlorosilyl, and the trialkoxysilane groups have significantly different reactivity than terminal groups on the other side of the SAM molecule, e.g. pyridine (—C₅H₄N), methyl (—CH₃), phenyl (—C₆H₅), and mercaptan (—SH), and thus the SAM molecule will not react with itself. SAMs anchored by trichlorosilyl or trialkoxysilyl groups may be used with barrier layers that have been hydroxylated in a separate step.

A monolayer mercaptan SAM from a starting chemical 3-mercaptopropyltrimethoxysilane can form a one monolayer thick film on dielectric or diffusion barrier material under certain conditions. The material first needs to be functionalized with hydroxyl groups for bonding to occur with the mercaptan SAM's. The following reaction takes place between the hydroxylated surface and the mercaptan SAM:

R—OH+R′—(OCH₃)₃->R—O—R′+HOCH₃ (2)

where R can be but is not limited to silicon, carbon, tantalum (TaN), titanium (TiN) or any material that can form an oxide, which may include polymeric materials. R′ is typically silicon since the SAM's are alkoxy silanes; and attached to but not limited to S, P, I, or Br via a hydrocarbon chain. A silicon wafer of no preferential orientation, electrical resistivity, or grade of wafer are functionalized with hydroxyl groups by a RCA-1 clean 5:1:1 DI-H₂O, conc. NH₄OH, conc. H₂O₂. This may take place at 70° C. for 2 min. but surface hydroxylation may take place sooner. The RCA-1 also cleans the surface from adventitious carbon, which may negatively impact bonding of the SAM to the surface. Other ways to clean the surface of adventitious carbon and leave it hydroxylated may also be used. In addition, it may be desirable to control water as the hydroxylated surface, since this may affect growth of mercaptan-terminated SAM's.

### EXPERIMENTAL

### Sulfur Passivation of Dielectrics for Metallic Thin Film Deposition

### EXAMPLE 1

### Apparatus For the Deposition of Metallic Films and Self-assembled Monolayer/multilayer Films

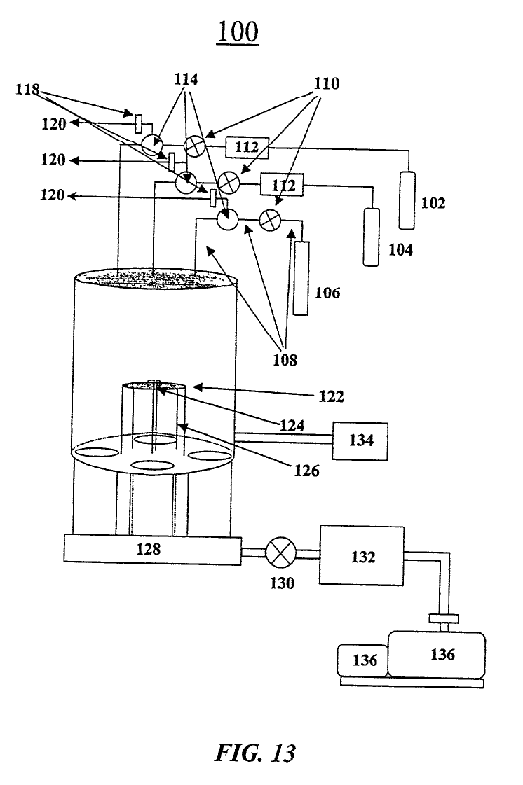

FIG. 13 shows a schematic diagram of a vacuum system 100 of an embodiment of this invention for depositing metallic thin films by atomic layer deposition or chemical vapor deposition using metallorganic precursors and deposition self-assembled monolayer/multilayer passivated dielectrics. The ‘cleaving’ gas or liquid is contained in a cylinder or chamber 102. Examples of ‘cleaving’ gases are the following, but not limited to, H₂, H₂O, O₂, and N₂O depending on whether a metal or a SAM is desired for deposition. The purge or carrier gas is contained in a cylinder 104. Examples of purging gases are the following, but not limited to, Ar, He, N₂. The metallorganic precursor or SAM molecule is contained in a vacuum tube 106. This can be a solid-source or liquid-source delivery system. The flow can be regulated by controlling the temperature of this tube 106 or by a mass-flow controller. For palladium using Pd^{II}(hfac)₂ the temperature is 34.8° C. and a range between 25-70° C. For copper using Cu^{II}(hfac)₂ the temperature is 54.5° C. and a range between 40-90° C. For SAM's using 3-mercaptopropyltrimethoxysilane and bis[3-(triethoxysilyl)propyl]-tetrasulfide room temperature is the preferred embodiment with a range of 0-40° C. The flow of the gases and high vapor pressure liquids is controlled by mass-flow controllers (MFC's) 112. The purging gas is Ar with a preferred flow of 100 sccm with a range of 20-1000 sccm. The cleaving gas for metallorganics is 25% H₂ in Ar with a range of 1-100% H₂ and a flow of 20 sccm with a range of 1-1000 sccm. The cleaving gas is H₂O for multilayer SAM's with a flow of 10 sccm and a range of 1-100 sccm. The packless diaphragm valves 110 can control pressure surges due to buildup of gas after the pneumatic valves 114 are shut and between the pneumatic vales 114 and the MFC's 112. The pneumatic valves 114 are opened by solenoids 118 allowing air to enter the pneumatics and controlled by a CPU 120 with a 24 VDC switching card.

The substrate platform 122 is heated and the chamber has electrical feedthroughs 126 for heating and thermocouple feedthroughs 124 for temperature measurement. The chamber has an attached 10 Torr capacitance manometer 134 for pressure measurement. The backside of the chamber has a manifold 128 to allow adequate conductance (flow) through the system. For an atomic layer deposition chamber, the reactants are pulsed into the chamber therefore faster pulsing times favor higher deposition rates. The chamber should then be small and possess a high conductance. A bellows valve 130 isolates the mechanical roughing pump 136 from the system and a foreline trap with stainless steel, bronze or copper gauze helps trap backstreamed oil.

### EXAMPLE 2

Apparatus For the Atomic Layer Passivation of Dielectric Substrates

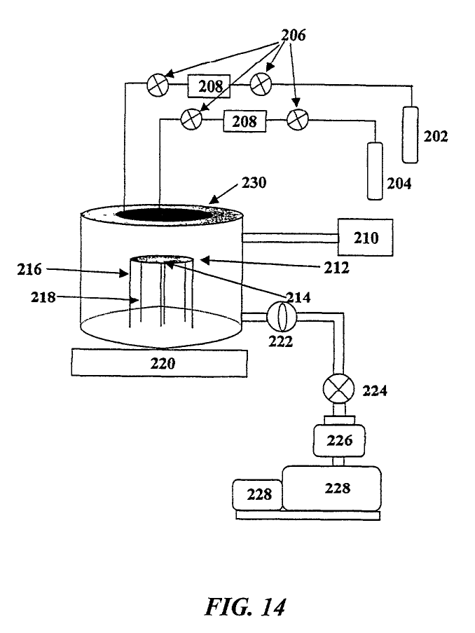

FIG. 14 shows a schematic diagram of a vacuum system 200 of an embodiment of this invention for atomic layer passivation of dielectric materials. The vacuum system 100 can be easily modified to comprise 200 additionally but for the purposes of this invention they are separate. The main advantage of having both processes conducted in the same system is when the passivation film is easily oxidized under atmospheric conditions. In the case of sulfur and phosphorous, these passivation films are stable under most atmospheric conditions.

The following gases, but not limited to those, can be used for atomic layer passivation hydrogen sulfide, phosphine, stibine, hydrogen telluride, and hydrogen selenide. They are contained in a cylinder 202 pure or as a mixture (e.g. He, N₂, Ar). A secondary gas, for example, He, Ar, N₂ but not limited to those may be used to strike a plasma before the active passivation gas enters the chamber and they are kept in a cylinder 204. Diaphragm or packless valves 206 help isolate the cylinders or the mass-flow controllers 208 which are used to regulate the flow of gases into the vacuum chamber. A showerhead diffuser 230 acts to diffuse the gas over the substrate 212. An RF powered substrate 212 creates a capacitively coupled RF plasma between the bottom powered substrate and the metallic showerhead diffuser 230. Water feedthroughs 218 and RF feedthroughs 216 exist to control substrate temperature and to power the substrate or the electrode. A RF tuning network exists 220 to match the plasma impedance with the impedance of the RF power supply. A throttle valve 222 linked with the capacitance manometer 210 helps regulate the system pressure by controlling the pumping speed of the roots blower 226 mechanical roughing pump 228 system. A foreline valve 224 isolates the pump from the vacuum chamber.

### EXAMPLE 3

### Sulfur Passivation of Dielectric Materials via Self-Assembled Chemistry: Growth of Monolayer and Multilayer Mercaptan SAM's and Tetrasulfide and Iodo SAM's

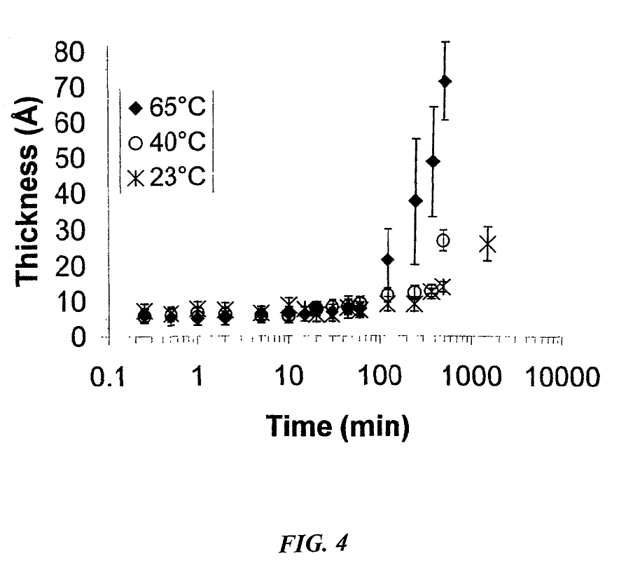

Before any deposition of metallic thin films can take place, first the growth of the sulfur-based SAM's should be characterized. FIG. 4 shows the growth of 3-mercaptopropyltrimethoxysilane (mercaptan SAM) as a function of time using variable angle spectroscopy ellipsometry (VASE). The monolayer mercaptan SAM grows rapidly to one monolayer and then will grow multilayer films, at times approximately >60 min. During this time, the surface chemistry of the film changes, which influences the growth of metallic films. Sulfur may exist in various oxidation states affecting its ability to bond to metals. The forms of sulfur encountered for the mercaptan SAM's are mercaptan (—SH) (−2), disulfide and tetrasulfide (—SS— and —SSSS—)(−1), sulfinic acid (—SO₂H)(+2), and sulfonic acid (—SO₃H)(+4). Since adjacent mercaptan groups ‘spontaneously’ cross-link in the presence of oxygen, e.g. air, these surfaces are unlikely present when mercaptan SAM's are used (Torchinskii, Sulfhrydryl and Disulfide Groups of Proteins; Consultants Bureau: New York, N.Y. (1974) pp. 51-4) The most appropriate substrate for metallic deposition is the disulfide or tetrasulfide species since the oxides weakly interact with the ‘soft’ metals, which are those metals that are large and have a relatively large electronic polarizability. They would include but are not limited to Zn, Cd, Hg, Cu, Ag, Au, Ni, Co, Pd, Rh, Pt, Ir, Ga, In, Ti, Pb, Sn, Sb, and Bi. These metals are in contrast to the ‘hard’ atoms such as Sc, Ti, V, Cr, Y, Zr, and Mo. Hard/Soft nomenclature has been borrowed from acid base chemistry (Huheey, Inorganic Chemistry 3^{rd} Ed. Harper Collins, New York, N.Y. (1983) pp. 312-325).

A method presented here to ‘probe’ the surface chemistry of the SAM and ALP surfaces is with pulsed deposition akin to atomic layer deposition (Atomic Layer Epitaxy, Suntola Ed. et. al., Blackie, Glasgow (1990)). The simplest experiment conceived to probe the sulfur passivated surfaces is with the use of a β-diketonate palladium precursor Pd^{II}(hfac)₂ (palladium (II) hexafluoroacetylacetonate) pulsed twice with an inert gas purge, e.g. Ar or N₂. Pd^{II}(hfac)₂, an appropriate ALD precursor, exhibits self-limiting chemistry until ˜230° C. and therefore can form one monolayer on an appropriate surface that promotes chemisorption. With the addition of an appropriate reducing agent multilayer palladium can be grown. However, whether chemical vapor deposition or atomic layer deposition is undertaken, the precursor has to first chemisorb at the surface before any further reaction can take place. Since gas-phase thermal decomposition of the precursor takes considerably more energy, at low pressures, e.g. <1 Torr, than at a surface, the illustrations presented here have much meaning. Such consideration makes the experiments universal for the vacuum deposition of metals. A further point should be mentioned, namely the beta-diketonate precursors have a similar structure, e.g. acac (acetylacetonate), tmhd (tetramethylheptanedioate), hfac (hexafluoroacetylacetonate), and fod (heptafluorodimethyloctanedionate), and therefore the claims here can be applicable to many metallorganics. It is thought that the β-diketonate ligands may be able to bend away from the surface allowing the metallic center atom to interact with the surface in such cases then the aforementioned ‘soft’ metals will interact with sulfur passivated surfaces but other ‘hard’ metals will have a difficult time (Girolami et al. J. Am. Chem. Soc. 115:1015-1024 (1993)). The exact mechanism of how β-diketonate precursors interact with, for example, metallic and dielectric surfaces is not well established (Cohen et al. Appl. Phys. Lett. 60(13):1585-1587 (1992)).

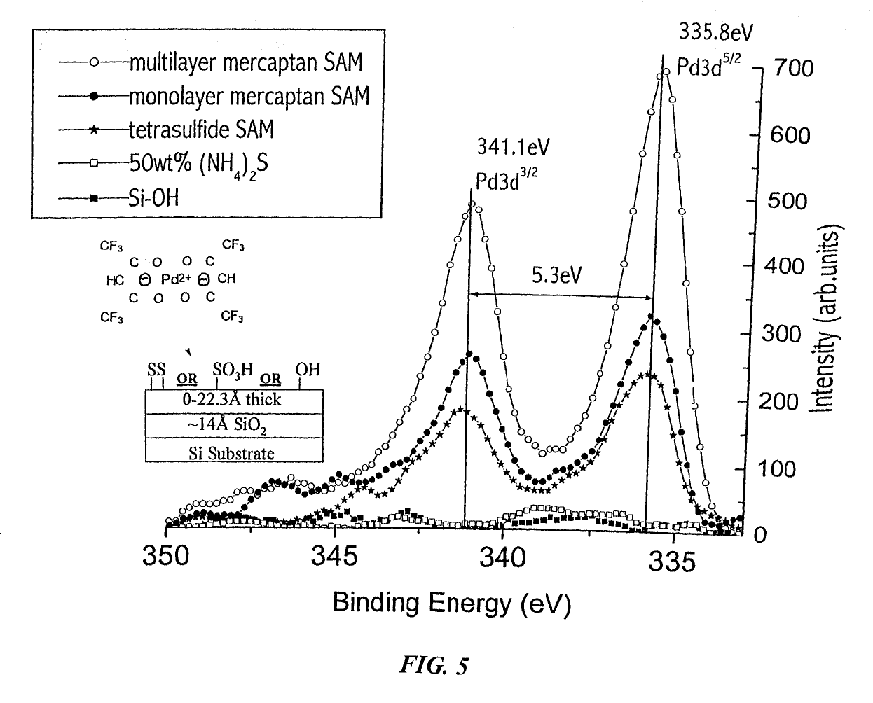

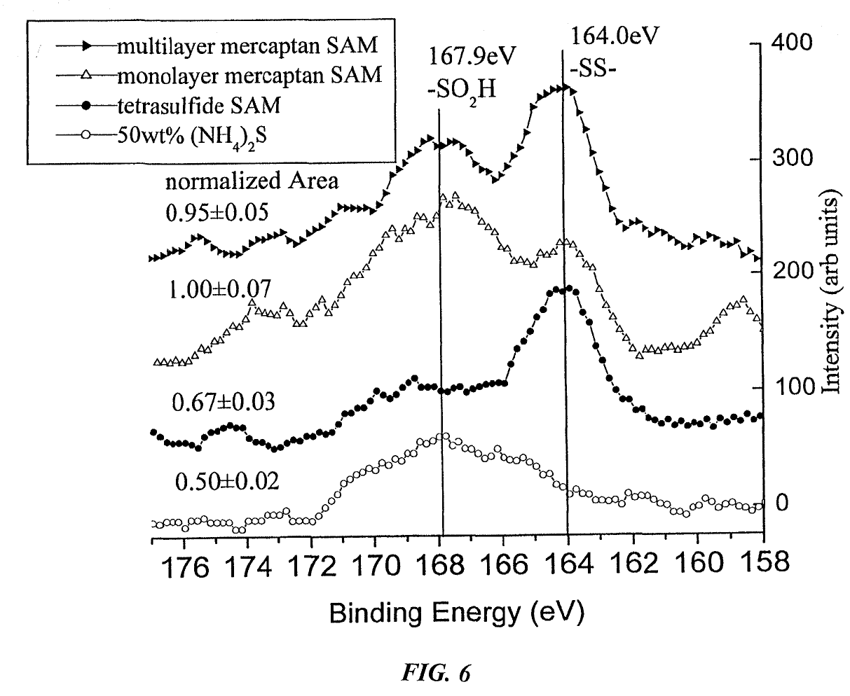

FIG. 5 shows the Pd3d_{5/2} and Pd3d_{3/2} X-ray photoelectron (XPS) spectra and how various surface passivations influence the growth of Pd^{II}(hfac)₂ pulsed twice for 20s with an argon purge between pulses. The inlet shows the structure of Pd^{II}(hfac)₂ and the structure of the surface. This experiment is by way of example and the claims here are more universal to include all the metallorganic precursors that contain the preferred ‘soft’ metals and to a lesser extent the ‘hard’ metals also. What is apparent from FIG. 5 is the large difference between the various surfaces and how they influence metallic thin film deposition. FIG. 6 shows the S2p XPS spectra and allows identification of the surface species before palladium deposition is undertaken. Palladium is an especially good ‘probe’ metal since it is noble and will not oxidize ex situ and therefore the oxidation present in the XPS spectra in FIG. 5 is due to lack of reduction in the precursor only and not ex situ oxidation. Also, copper and other soft metals have very similar properties to palladium, so what is possible with palladium, will be possible with many other ‘soft’ metals.

The two primary factors that influence the deposition of palladium in FIG. 5 are the nature of the sulfur on the surface, e.g. disulfide or tetrasulfide (—SS— or —SSSS—), oxidized sulfur (—SO₂H or —SO₃H), or the absence of sulfur, e.g. surface coverage. These two factors are readily apparent from FIG. 6. XPS can only distinguish between reduced and oxidized sulfur but not differentiate between the various types of oxidized and reduced sulfur. Two peaks are readily apparent from FIG. 6, one at 164.0 eV due to —SS— and one at 167.9 eV broad and due to either —SO₂H or —S_{O}₃H. Mercaptan groups maybe ruled out since the surface is exposed to oxygen and thus these surfaces ‘spontaneously’ cross-link. Further, the surface coverage of both the mercaptan SAM's is nearly the same and sulfur only resides on the surfaces of the SAM's even in the multilayer case. This is due to condensation of methanesulfonic acid. The exact mechanism is not important to the art and will not be discussed here. The surface coverage of the tetrasulfide SAM (bis[3-(triethoxysilyl)propyl]-tetrasulfide) is about 60%, as measured from auger electron spectroscopy (AES), and is less than that of either the mercaptan SAM's. Since the multilayer mercaptan SAM and the tetrasulfide SAM have similar chemical bonding, the difference in the Pd3d intensity is reflected in the surface coverage. However, what is readily apparent is that oxidized sulfur does not yield strong interaction with the palladium precursor. This surface is similar to that of hydroxylated SiO₂ since both surfaces have hydroxyl groups (—OH), however, sulfur is more polarizable compared to silicon, which may influence metallorganic deposition.

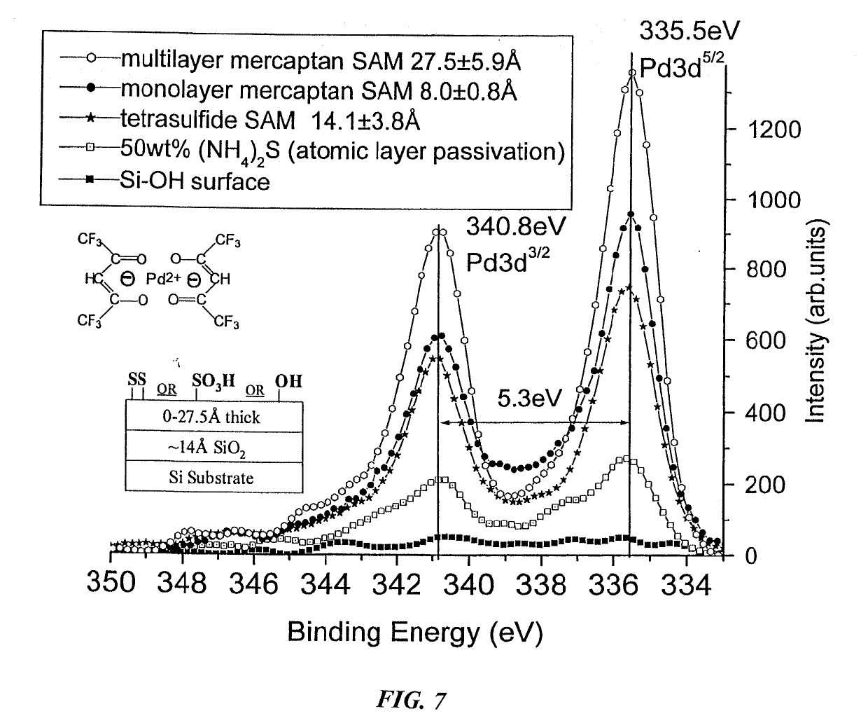

FIG. 7 shows the same spectra as in FIG. 5 but with the series of pulsing sequences Pd/Ar/H₂/Ar (20s/3s/20s/3s) then repeated a second time. What is readily apparent is the intensity and ‘sharpness’ (little asymmetry) that exists in these peaks compared to pulsing without hydrogen. Also, the ammonium sulfide modified Si—OH surface now has some intensity. Since the first pulse of Pd^{II}(hfac)₂ is the same in FIGS. 5 and 7 then the hydrogen pulse influences the surface chemistry allowing for deposition to occur, in the case of ammonium sulfide modified Si—OH, and higher quality deposit to occur, in the case of the SAM-modified surfaces. The Pd3d_{5/2} peak at 335.5 eV is the value reported by other researchers for ‘pure’ palladium (Brun et al. J. Electron Spect. Related Phen. 104:55-60 (1999)). The spectra in FIG. 7 still contains some fluorine and carbon due to dissociative chemisorption of the precursor, mostly since H₂ is not flowed continuously with the Pd^{II}(hfac)₂.

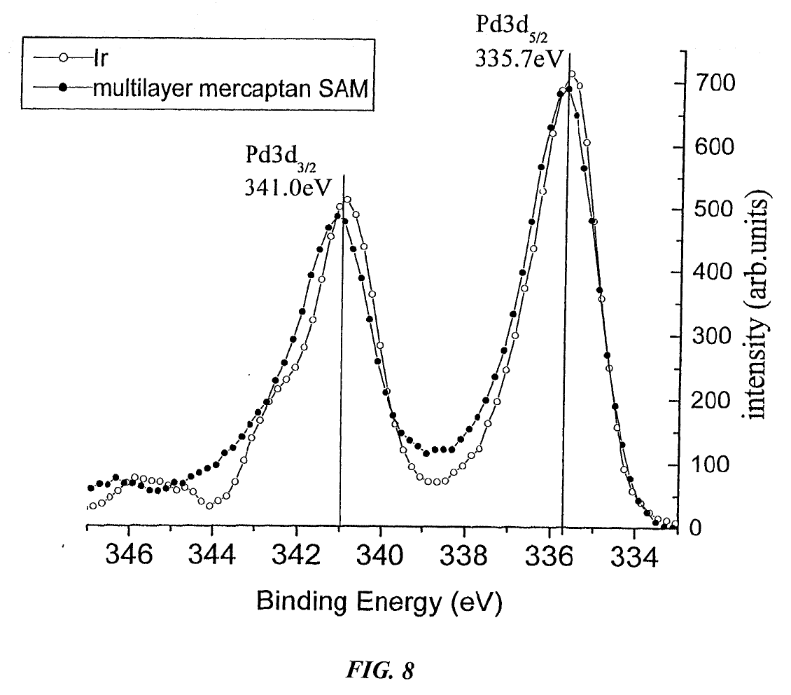

A good comparison between the degree of interaction between Pd^{II}(hfac)₂ and the disulfide species contained on the surface of the multilayer mercaptan SAM is to compare it with an iridium surface. Noble metals are known to interact very favorably with β-diketonate precursors. FIG. 8 shows the Pd3d_{3/2} and Pd3d_{5/2} spectra for the deposition of palladium using the pulse sequence Pd/Ar (20s./3s.) then repeated using Pd^{II}(hfac)₂. The spectra are nearly identical. The iridium does show slightly higher quality and a slight shift towards lower binding energies. This is not totally unexpected since the multilayer mercaptan SAM does not possess perfect 100% coverage of disulfide (—SS—) species. However, FIG. 8 does show the efficacy of —SS— as a surface passivation on dielectrics.

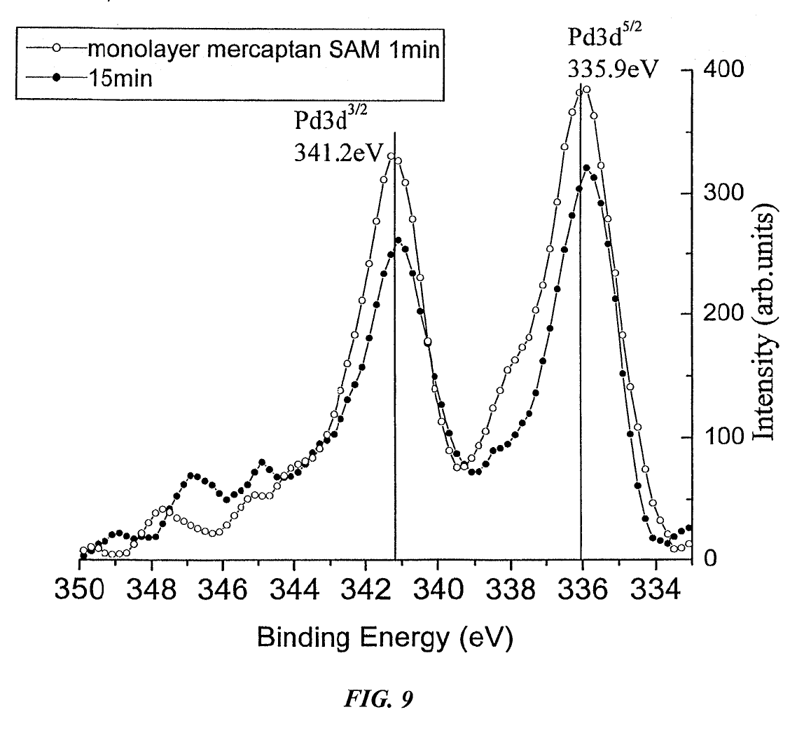

Further, it was stated earlier that the mercaptan SAM surface chemistry changes as a function of time, that is the time the SAM is exposed to the wet chemistry. FIG. 9 shows the monolayer mercaptan SAM dipped for 1 min and 15 min. With time the monolayer mercaptan SAM becomes more reduced due complex reasons that will not be discussed here. The monolayer surface coverage is very rapid for the mercaptan SAM. In as little as 15 s a monolayer of mercaptan SAM is bonded to the surface. FIG. 9 essentially reflects the chemistry of the sulfur surface, namely the same amount of Pd^{II}(hfac)₂ is deposited on each surface because it has the same type and amount of reduced sulfur at its surface.

Control of water at the hydroxyl surface may be important since it controls the growth of the mercaptan SAM's. Up until 30 min the mercaptan SAM only grows one monolayer at the Si—OH surface with a thickness of 8.0±0.7 Å measured by variable angle spectroscopic ellipsometry. An index of refraction was assumed to be 1.458 at 634.1 nm. Both the index of refraction and the thickness cannot be measured with films <50 Å since psi and delta are over correlated in films this thin. SAM passivation of dielectric can take place at above room temperature but the reactivity of the first monolayer is no different if the solution is kept at room temperature, at 40° C. or at 65° C.

Multilayer growth takes place at longer dip times and only after the mercaptan surface is adequately oxidized to yield a species like methanesulfonic acid to allow the mercaptan SAM to grow thicker. As can be seen from FIG. 4, once multilayer growth is initiated the mercaptan SAM grows rapidly and after 480 min the thickness is ˜12 Å (at 23° C.) to ˜72 Å (at 65° C.) as seen in FIG. 4. After growing the mercaptan SAM for 24 hrs. at 23° C. the surface chemistry changes as seen in FIG. 6. The multilayer SAM has a higher percentage of disulfide species (—SS—) appropriate for the deposition of ‘soft’ metals as shown in FIGS. 5 and 7.

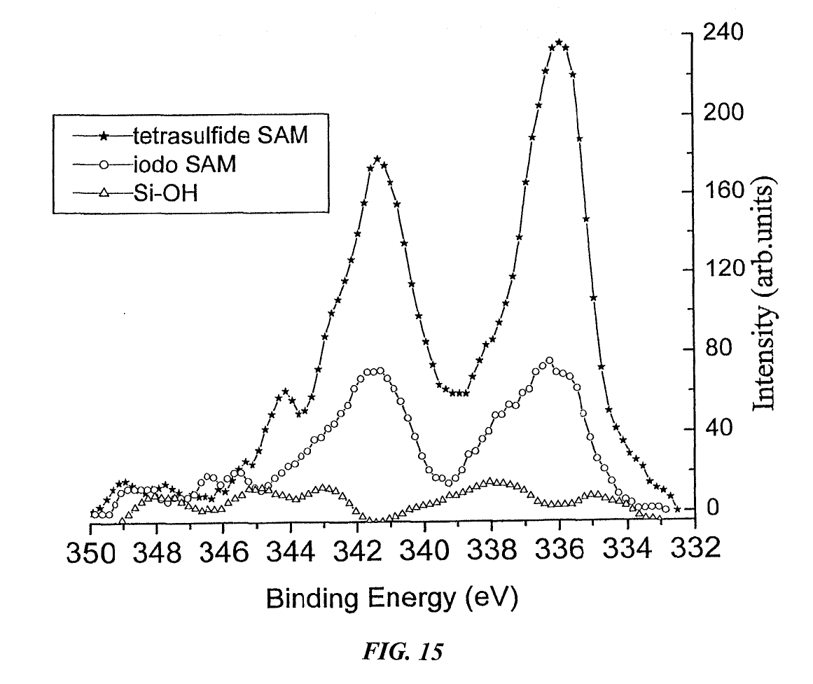

Two additional surfaces are appropriate for the deposition of ‘soft’ metals such as, but not limited to, palladium and copper. Tetrasulfide SAM (from bis[3-(triethoxysilyl)propyl]-tetrasulfide and iodo SAM (from 3-iodopropyltrimethoxysilane). The deposition of palladium on the tetrasulfide SAM by pulsed Pd^{II}(hfac)₂ without and with H₂ are shown in FIGS. 5 and 7. The quality of the sulfur on the tetrasulfide SAM is of high quality (from FIG. 6) but its surface coverage is low (integrated area of FIG. 6) and therefore the amount of palladium deposited on this surface is low compared to the mercaptan SAM which exhibit higher packing densities. The iodo SAM is compared to the Si—OH and tetrasulfide SAM surfaces in FIG. 15. The interaction appears to be weaker between Pd^{II}(hfac)₂ and iodine versus sulfur but is still much stronger then with a hydroxylated surface.

### EXAMPLE 4

### Atomic Layer Passivation of Silicon Dioxide using Hydrogen Sulfide/Helium RF Plasma

Self-assembled monolayer/multilayer modification of dielectric surfaces can be undertaken in both dry and solution-borne environments. However, in either case an appropriate surface must exist to bond the SAM's to the dielectric surface. Normally, an appropriate surface would be a hydroxylated one (R—OH), however, other surfaces are appropriate also such as: R—NH₂, R—SO₃H, R—H to name a few but not limited to those. However, most dielectric surfaces do not contain such chemical moieties intrinsically and therefore processing needs to be undertaken before SAM surface modification can be undertaken.

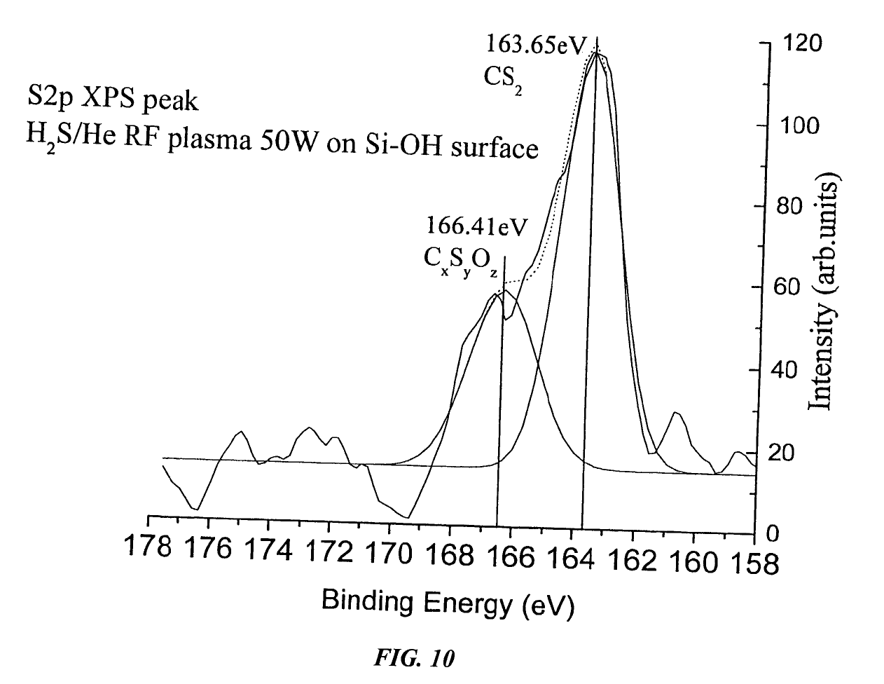

A potentially simpler process is to use a gas to modify the surface in situ where subsequent metallic deposition can occur. By way of example, a hydroxylated SiO₂ surface with native oxide was used to deposit palladium via Pd^{II}(hfac)₂. FIG. 10 shows sulfur atomic layer passivated Si—OH with 50W RF power with He added to increase ionization in the plasma and improve process uniformity. The area under the curve in FIG. 10 is less than ⅓ of the mercaptan SAM's in FIG. 6. This hints at sub-monolayer coverage, however, it is most likely due to the formation of CS₂ or some carbon sulfide analog since a rather large carbon peaks results from the surface modification. From the experiments conducted for this work it is known that Pd^{II}(hfac)₂ does not interact with hydrocarbon/carbon based surfaces. The asymmetry of the S2p peak in FIG. 10 towards higher binding energies maybe associated with some oxygen in the films due to reaction with the physisorbed moisture on the surface and the surface hydroxylation.

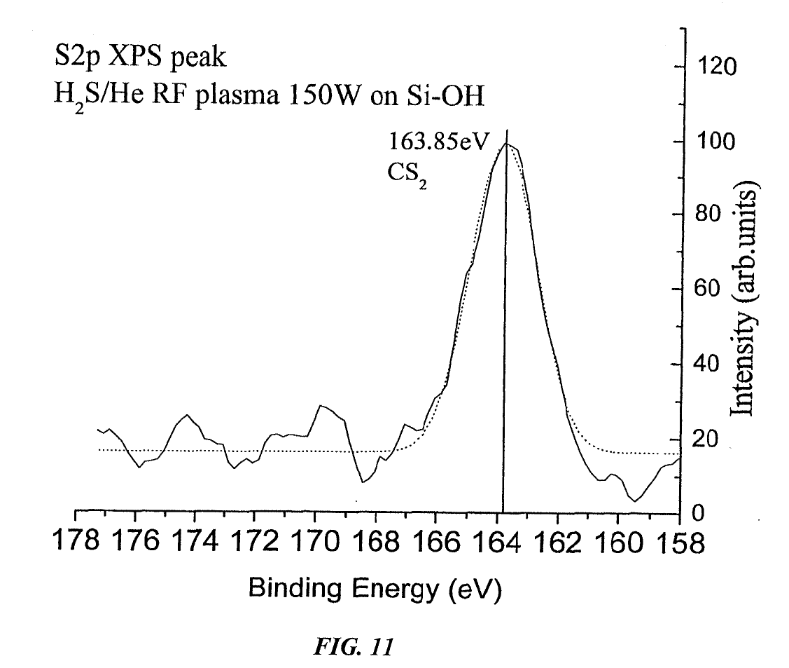

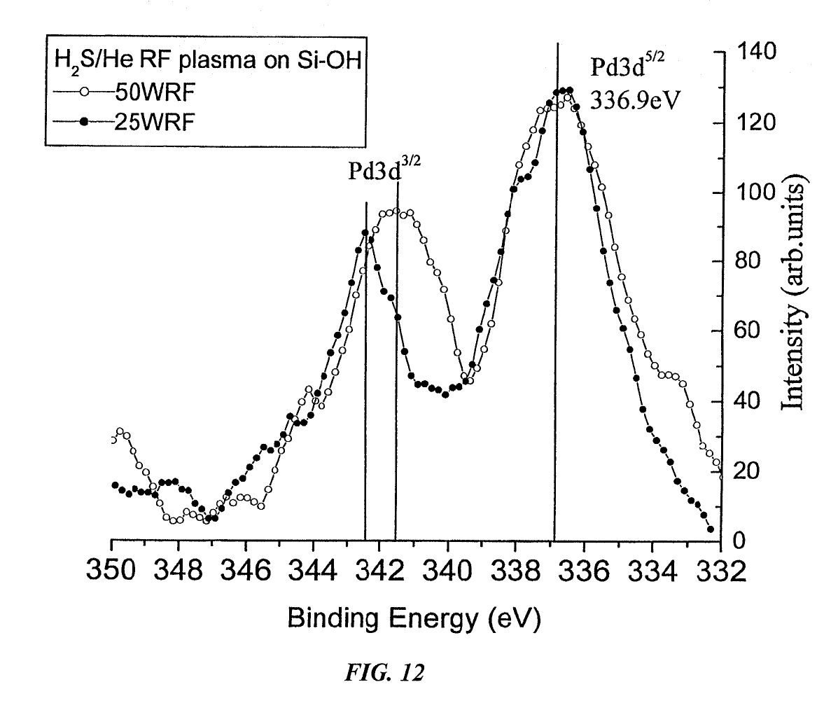

At higher RF powers this peak disappears as seen in FIG. 11. Higher RF powers create a larger DC self-bias causing an elimination of the oxidized sulfur but potentially less reduced sulfur surface coverage. The slight shift of the S2p peak to higher energies may reflect less carbon in the surface passivation also. Helium is used for these experiments since it is inert and also will not cause sputtering of the surface. The use of argon or other noble gases might be useful but only at low DC self-biases since higher biases will cause sputtering not allowing simple surface passivation to take place. When Pd^{II}(hfac)₂ is deposited on these surfaces it shows a reduced intensity compared to the mercaptan SAM but not much less than the tetrasulfide SAM. Comparing the relative intensities of the Pd3d_{5/2} peaks for the ALP sulfur and the tetrasulfide SAM the ALP is roughly half of that of the tetrasulfide SAM reflected in the integrated area of the S2p peaks for the respective deposition methods. FIG. 12 shows the Pd3d_{5/2} and Pd3d_{3/2} peaks for the ALP sulfur passivated SiO₂ surfaces. The Pd3d_{5/2} peak for the ALP sulfur is centered at 336.9 eV that is shifted from elemental palladium of 335.4 eV and the tetrasulfide SAM shows a peak at 336.2 eV. The larger the integrated area for the two 20 sec Pd^{II}(hfac)₂ pulses, the higher the quality of the deposit.

Since in certain applications the resistance from metal film to metal film is critical atomic layer passivation was developed to minimize this contact resistance, for example, in vias for semiconductor devices. In this example a capacitively coupled RF plasma (13.56 MHz) was used to functionalize silicon dioxide surfaces. However, the same chemistry will work on microwave plasmas (microwave cavity, electron cyclotron resonance) and other RF plasmas (inductively coupled) both remote and near-surface plasmas (the sample is placed on the powered electrode).

The silicon dioxide surface was first cleaned in a RCA-1 solution until the surface became hydrophilic to create a well-defined surface, however, it could have been hydrophobic. Then the surface was dried under atmospheric conditions at 130° C. for >2 min. to drive off excess physisorbed water. The sample was placed in the capacitively coupled RF plasma reactor 200 and 200 sccm (50-500 sccm for this system) of He was flowed through the reactor to purge out any impurities from the vacuum system. The temperature of the reactor was kept at but not limited to 10° C.; however, the temperature was not critical. The RF power was set to 25 or 50W where the electrode was 8″ in diameter. A range of 5-600W RF would work in a similar way. A flow of 200 scmm of He was continued to flow with the pump throttled to allow a base pressure of 100 mTorr to exist in the vacuum chamber. The He plasma existed for but not limited to 20 s. and then 200 sccm of H₂S was flowed in the vacuum system. A range of 1-500 sccm of H₂S would work equally as well.

The He/H₂S mixture was flowed for 2 min. (0.5-5 min also good). The vacuum system was then vented and the sample was taken out. A thin film was apparent at the surface. The film started to change its optical qualities after ˜10 min. However, a film still existed on the surface after longer times ˜30 min. The film could be sublimed above ˜110° C. in vacuum in a separate vacuum chamber or in the metallic deposition reactor 100. FIG. 10 shows the surface of the silicon dioxide after 25 WRF of power was used. It shows evidence of oxide mixing with the sulfur at the surface. It is also apparent that the sulfur is sub-monolayer comparing FIG. 10 to FIG. 6 (monolayer and multilayer mercaptan SAM's). When the RF power was increased to 50W, the oxidized sulfur peak disappeared and thus the S2p XPS peak only shows elemental sulfur (e.g. —SS—) or maybe a slight CSₓ surface.

Pd^{II}(hfac)₂ was pulsed over the sulfur atomic layer passivated surfaces as shown in FIG. 12. Essentially, no difference exists between the surface passivated at 25 WRF and the one at 50 WRF. However, the degree of interaction between these surfaces and the mercaptan SAM's is significantly less (FIG. 5).

### EXAMPLE 5

### Phosphorus Passivation of Dielectric Materials via Atomic Layer Passivation

Tantalum and iridium were e-beam deposited on Si(100) wafers and used as-deposited. Trikon and SiLK were obtained from LSI-Logic and IBM respectively and the native oxide of Si(100) was used for the SiO₂ surface. The SiO₂ surface was further exposed to a RCA-1 clean, 5:1:1 ratio of DI-H₂O:NH₄OH:H₂O₂ at 70° C. for 2 min to make it hydrophilic and further exposed to 10:1 dilution of conc. HF to make it hydrophobic if desired. The hydrophobic SiO₂ surface can be generated by starting with a hydrogen terminated surface then waiting until oxide growth starts. The thickness of the oxide layer can be measured using Variable Angle Spectroscopic Ellipsometry. Phosphorus atomic layers were deposited on SiO₂, Trikon and SiLK via a thick phosphorus layer, with a capacitively coupled RF Plasma, and then this layer was subsequently sublimed in situ in the chamber where the palladium monolayers were deposited. The dielectric samples were placed in the plasma chamber and exposed to a He 50W Rf plasma (8″ diameter Al electrode) throttled at 120 mTorr with 200 sccm 99.999% He (Air Products, Hometown, Pa.) at ˜14° C. obtained via a water cooled bottom powered electrode. After 20s of exposure to the He plasma, 200 sccm of 99.9995% PH₃ (Voltaix, Branchburg, N.J.) was flowed for 2 min. A thick phosphorus layer resulted and this layer protected the atomic layer from attack by atmospheric conditions. The thick phosphorus layer was sublimed at 255° C. for 10 min with a system base pressure of 10 mTorr and using 100 sccm of Ar as a purge gas. Subsequently, palladium (II) hexafluoroacetylacetonate (Gelest, Tullytown, Pa.) was sublimed at 34.8±0.2° C. and the deposition temperature was 175±5° C. The chamber walls were at 90° C. and the temperature between the sublimation chamber and deposition chamber was kept 30° C. above the sublimation temperature to prevent metallorganic condensation. Two pulses of PdI(hfac)₂ of 20 s each while 100 sccm of Ar purge gas were undertaken to investigate the chemisorption behavior of the various surfaces studied here.

The thermal decomposition of Pd^{II}(hfac)₂ was obtained at a sublimation temperature of 49.8±0.2° C. with a 10 sccm Ar carrier gas and 10 sccm Ar purge gas. The base pressure of the system was <1 mTorr with the presence of a roots blower. The aerial density of the palladium thin films were obtained via Rutherford Backscattering Spectrometry with a 2.0 MeV He⁺ from a RPEA 4.0 MV Dynamitron accelerator at the Ion Beam Laboratory at the University at Albany with the 30° beam line. The beam was 10 □C. and with 30 nA of current. XRUMP was used to calculate the integrated area of the gaussian peaks (of Pd) to arrive at the aerial density of the Pd. A Perkin-Elmer 5500 X-ray Photoelectron Spectrometer with a Mg K□ (1.253 keV) source was used to characterized the bonding at the surface of the films. The X-ray beam diameter was 1.5 mm and an electron take-off angle of 45° was used for analysis. Each sample was loaded into the UHV chamber and allowed to out-gas for a minimum of 12 hrs until a base pressure of <1×10⁻⁹ Torr was reached. A binding energy of 99.15 eV was used for elemental silicon and 284.6 eV was used for adventitious carbon to calibrate the binding energy for the spectra. The scan rate for the Pd3d peaks was 50 ms/step, 0.2 eV/step, and 20 sweeps/spectrum and for the low the resolution spectra 50 ms/step, 0.8 eV/step, and 3 sweeps/spectrum.

### EXAMPLE 6

### Sulfur Plasma Passivation of Oxidized Ta via Hydrogen Sulfide

An immediate interest for the semiconductor industry is to metallize Ta based barrier layers. However, Ta, TaN, and TaSiN readily oxidize with exposure to ambient conditions. Copper metallorganic precursors do not chemisorb on the oxidized surface and these oxidized surfaces show poor wetting and adhesion towards copper deposits. Passivating air exposed Ta surfaces would greatly improve the interface between Ta based diffusion barriers and the copper deposit and its resulting structure and properties.

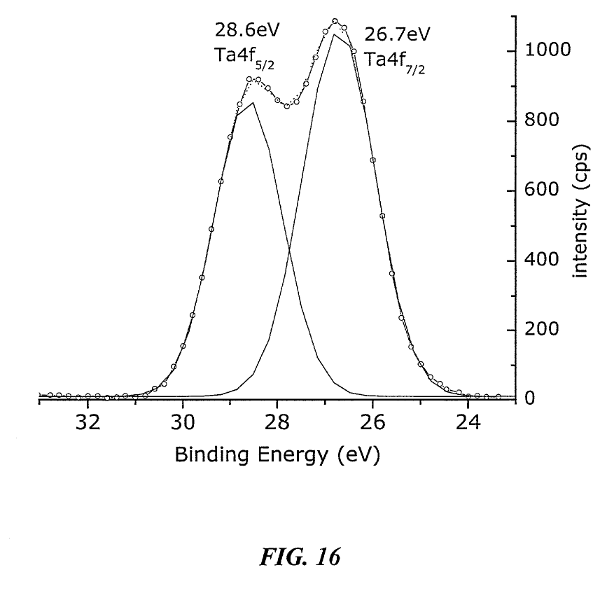

Elemental tantalum readily forms thick (by XPS standards, FIG. 16) oxide layer under ambient conditions and exhibits a binding energy of 26.70 eV for the Ta4f_{7/2} peak with a 1.91 eV spin orbital splitting between the 4f_{7/2} and 4f_{5/2} peaks. When exposed to the H₂S/He plasma, at 25 W Rf power no sulfur was evident even though a thick overlayer of sulfur was present. This is in contrast to the SiO₂ surface, where even at low Rf power, sulfur passivated it. Additionally, H₂S reacted with SiO₂ even without the use of a plasma, and it was difficult to achieve just reduced sulfur passivation on SiO₂. A separate oxidized sulfur peak was evident at 166.3-169.0 eV and attributed primarily to a sulfonic acid chemical moiety but other oxidized sulfur groups could have been present also. Sulfonic acid as part of NH₂—C₆H₄—SO₃H has been shown to have a S2p peak at a binding energy of 167.8 eV whereas, dimethysulfone has been shown to have a S2p peak binding energy of 169.0 eV. Likely analogous to the salts of hyposulfite, sulfite, and sulfate compounds, sulfinic and sulfonic acids would have a greater binding energy as more oxygen is placed adjacent to the sulfur atom.

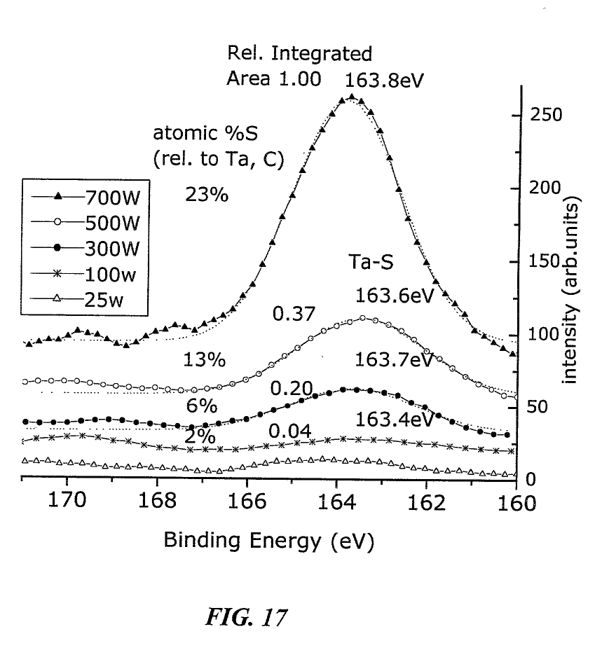

At 100 W Rf power, two small peaks were evident in FIG. 17, one at 163.4 eV attributed to TaS_{X} and one at ˜169 eV attributed to Ta—SOxH; however, both peaks were small and not much above the background. Quantitative analysis via Rutherford Backscattering Spectrometry (RBS) showed that the 100W sample had 1.2±0.3 Å. one monolayer maybe defmed in terms of the Tα (111) plane, as 0.96 ÅA or 5.3×10¹⁴ atoms/cm². A reference binding energy has not been established for TaS_{X} but WS₂ has been shown to have a binding energy of 162.9 eV and 163.0 eV for the S2P_{3/2} peak. Neither the hemispherical analyzer or the double pass cylindrical mirror analyzer (CMA) used with the X-ray photoelectron spectrometers in this study have the resolution to separate the S2P_{3/2} and S²p_{1/2} peaks (1.18 eV separation) and therefore the S2P_{3/2} peak is often just stated as the S2p peak. Further, the atomic sensitivity factors used, to calculate the relative atomic percent of each constituent element for the surface passivation, were from Wagner's data contained in the Handbook of X-ray Photelectron Spectroscopy for the double pass CMA configured spectrometers.

At 300W, 500W, and 700W of Rf power no oxidized sulfur peak was observed. It would appear that the S2p peak did continue to grow as the power was increased but this was not found via RBS analysis. At 500W and 700W no sulfur overlayer was deposited and the sulfur maybe implanted in the TaO_{X} surface. At 300W, the aerial density of sulfur was 2.5×10¹⁵ atoms/cm² as measured quantitatively by RBS. If the surface is assumed to be Ta(111), it appears that sulfur is bounded to the Ta within the TaO_{X} amorphous network, then a monolayer is defined as 5.3×10¹⁵ atoms/cm² based on a BCC structure with a lattice constant of 3.298 Å. This lends to sulfur being ˜3 monolayers thick at the surface from an equivalent thickness of 2.9-3.1±0.6 Å. At 700W, exhibited a peak at 163.8 eV, which may mean some pairing of the sulfur, forming —SS— linkages rather than just Ta—S bonding, occurred. Elemental sulfur (S₈), has a binding energy of 164.0 eV, which is what was previously observed with molecular layers

The Ta₄f XPS spectra do not lend any insight into the chemistry at the TaO_{X} atomic layer passivated surface because TaS, TaS₂, and Ta₂O₅ all have similar binding energies, 26.6 eV-26.7 eV. Therefore, the Ta4f_{7/2} peak at 26.7 eV was used to normalize the S2p and C1 s XPS spectra as opposed to the C1 s spectra, which is normally used. This is fortunate, since the origin of carbon might be from the CS₂ and COS impurities in the H₂S source, thus changing the binding energy of the primary carbon peak. The primary carbon peak is at 285.1-285.3 eV compared to 284.6 eV for adventitious carbon. However, it is not uncommon for the carbon peak to be shifted towards larger binding energies, especially when a second calibration standard is present, e.g. Ta₂O₅, Si, or SiO₂. The chemical shift for the TaO_{X}:S system is 0.50.7 eV but is not unreasonable if the carbon is associated to a greater degree with Ta or S.

The atomic concentration of C, Ta, and S can be calculated from the integrated area of the C1s, Ta4f and S2p peaks and atomic sensitivity factors. If the atomic concentration of these elements is plotted versus Rf power, it is apparent that carbon did not increase substantially except compared to the 25W sample where no sulfur passivation is evident. The carbon found on the surface of the 25W sample is equivalent to that measured with ex situ samples, i.e. aventitious carbon. With increasing Rf power, the atomic percent sulfur at the TaO_{X} surface increases, which is just the opposite of what was observed with native oxide of Si surface. This could be primarily to do with the thickness of the native oxide of silicon compared to the native oxide of tantalum. Then, sulfur cannot penetrate past the Si/SiO₂ interface. However, with increasing Rf power, the integrated area of sulfur decreased with the SiO₂ surface, just the opposite behavior as with the TaO_{X} surface.

What is claimed:

1. A method for metallizing a substrate, said method comprising
a. providing, in vapor form, a precursor for an element selected from the group consisting of sulfur, selenium, tellurium, phosphorus, antimony, iodine and bromine;
b. depositing, directly on a surface of the substrate, an atomic passivation layer comprising at least one of said elements; and
c. forming, directly on the atomic passivation layer, a metallic layer comprising at least one metallic element selected from the group consisting of Zn, Cu, Ni, Co, Fe, Sb, Sn, In, Cd, Ag, Pd, Rh, Ru, Bi, Pb, Tl, Hg, Au, Pt, Ir, Os, Re, W, Ta, Hf, Nd, Sm, Eu, and Gd.

2. A method according to claim 1, wherein said substrate comprises a dielectric material.1

3. A method according to claim 1, wherein said substrate comprises a diffusion barrier layer.

4. A method according to claim 1, wherein said substrate is selected from the group consisting of ceramic materials having an oxide surface, organic polymers and organic/inorganic hybrid materials.

5. A method according to claim 1, wherein said substrate comprises silicon having a silicon oxide surface.

6. A method according to claim 1, wherein deposition of the atomic passivation layer is plasma-enhanced, thermally-assisted or photo-assisted.

7. A method according to claim 1, wherein said precursor is selected from the group consisting of H₂S, R₂S, H₂Se, H₂Te, SbH₃, PH₃, R₃P, HI, I₂, RI, and Br₂, wherein R is alkyl or aryl.

8. A method according to claim 1, wherein said precursor is selected from the group consisting of H₂S and PH₃.

9. A method according to claim 1, wherein said atomic passivation layer comprises at least one element selected from the group consisting of sulfur and phosphorus.

10. A method according to claim 1, wherein said atomic passivation layer comprises sulfur.

11. A method according to claim 1, wherein said atomic passivation layer comprises phosphorus.

12. A method according to claim 1, wherein said metallic layer comprises at least one metallic element selected from the group consisting of Zn, Cu, Ni, Co, Fe, Cd, Ag, Pd, Rh, Hg, Au, Pt, Ir, and Os.

13. A method according to claim 1, wherein said metallic layer comprises at least one metallic element selected from the group consisting of Cu, Ag, Au, Pd, Pt, Ir and Os.

14. A method according to claim 1, wherein said metallic layer comprises Cu.

15. A method according to claim 1, wherein said metallic layer is formed by a process selected from the group consisting of chemical vapor deposition, electrochemical deposition, atomic layer deposition, and chemical fluid deposition.

16. A method according to claim 15, wherein said metallic layer is deposited from at least one metal source precursor comprising a metal β-diketonate.

17. A method according to claim 15, wherein said at least one metal source precursor is selected from Pd(hfac)₂, Cu(hfac)₂ and Cu(tmhd)₂.

18. A metallized substrate comprising
a. a substrate comprising a dielectric or a diffusion barrier layer;
b. an atomic passivation layer, directly disposed on a surface of the substrate, and comprising at least one element selected from the group consisting of sulfur, phosphorus, antimony, selenium, tellurium, iodine and bromine; and
c. a metallic layer directly disposed on the atomic passivation layer, and comprising at least one metallic element selected from the group consisting of Zn, Cu, Ni, Co, Fe, Sb, Sn, In, Cd, Ag, Pd, Rh, Ru, Bi, Pb, Tl, Hg, Au, Pt, Ir, Os, Re, W, Ta, Hf, Nd, Sm, Eu, and Gd.

19. A metallized substrate according to claim 19, wherein said metallic layer comprises copper.

20. A metallized diffusion barrier layer comprising
a. a diffusion barrier layer; and
b. a passivation layer, disposed directly on a surface of the diffusion barrier layer, and comprising a silyl-anchored self-assembled monolayer or self-assembled multilayer, terminated with at least one element selected from the group consisting of sulfur, selenium, tellurium, phosphorus, antimony, iodine and bromine.

21. A metallized diffusion barrier according to claim 20, wherein said passivation layer is derived from an alkoxy- or chlorosilane comprising an element selected from the group consisting of S, P, Sb, Se, Te, I and Br.

22. A metallized diffusion barrier according to claim 20, wherein said passivation layer comprises sulfur.
